(19) United States
(12) Patent Application Publication
(10) Pub. No.: US 2009/0222923 A1
(43) Pub. Date: Sep. 3, 2009

(54) Malicious Software Detection in a Computing Device

(75) Inventor: Jonathan Dixon, Surrey (GB)

Correspondence Address: Saul Ewing LLP (Philadelphia), Attn: Patent Docket Clerk, 2 North Second St., Harrisburg, PA, 17101, US

(73) Assignees: SYMBIAN SOFTWARE LIMITED, LONDON (GB); NOKIA CORPORATION

(21) Appl. No.: 12/158,103

(22) PCT Filed: Dec. 20, 2006
(86) PCT No.: PCT/GB2006/004821

§ 371 Date: Feb. 27, 2009

(30) Foreign Application Priority Data
Dec. 20, 2005 (GB) 0525871.0

(51) Int. Cl. G06F 12/14; G06F 21/00

(52) U.S. Cl. 726/24; 726/22; 711/E12.001; 711/E12.091

(57) ABSTRACT

A method of scanning for viruses in the memory of a computing device in which only memory pages marked as executable need to be scanned. The trigger for the scan can be either via an API that changes a page from writeable to executable, or via a kernel notification that an executable page has been modified. This invention is efficient, in that it makes much previous scanning of file systems redundant; this saves power and causes devices to execute faster. It is also more secure, as it detects viruses that other methods cannot reach, and does so at the point of execution.

This invention relates to a method for operating a computing device, and in particular to an improved method of scanning for malicious software in a computing device.

In the context of the present invention, the term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of device already mentioned, together with many other industrial and domestic electronic appliances.

There is now widespread public awareness that there is a significant risk for malicious programs (or malware) to affect computing devices, especially when the computing device is connected to other devices over a network. It is common for all instances of such malware to be generically termed a virus. However, security experts distinguish between many different types of malware. A recent Internet article (http://en.wikipedia.org/wiki/Malware) identifies and describes eleven different types, which include Viruses, Worms, Wabbits, Trojans, Backdoors, Spyware, Exploits, Rootkits, Key Loggers, Dialers and Browser Hijackers.

Malware can gain entry to a computing device in different ways. Many infections arise as a result of the user of a device being tricked into installing software that carries the infection. This route into the device can be relatively easily monitored by means of certification, authentication and verification of installable software packages and other code items such as macros. However, users do not always heed warnings given at the installation phase about the dangers of untrusted software. Additionally, malware is not restricted to installable executables and can spread through other means such as emails and email attachments.

For this reason, computing devices are increasingly being equipped with anti-virus software. Such software has traditionally worked by hooking into the file system of the host operating system, and scanning files as they are written to or read from disk. During this scan, they search for a unique series of bytes that can be used as a signature or fingerprint to identify malware. Most personal computer users are aware that they need to maintain the virus definition files for this type of software up to date if the method is to be effective.

Because the process of scanning on-the-fly is fallible (for instance, it cannot detect potential malware infections on removable media) most types of anti-virus software are often run periodically in a deeper batch mode, during which the full contents of the entire file system is analysed looking for the fingerprints referred to above.

However, anti-virus software which scans only the file system cannot catch all malware. It is known that there are other ways apart from the file system through which devices can be infected; security holes which can be exploited by malware to allow its code to be executed on a computing device are known to be found on a regular basis, either in the operating system that controls the computing device, or in software packages which it commonly uses.

An article at http://en.wikipedia.org/wiki/Exploit_(computer_science) lists a number of such exploits, including buffer overflow, integer overflow, memory corruption, format string attacks, race condition, cross-site scripting, cross-site request forgery and SQL injection bugs. Malware entering a device via many of these routes might reside entirely in memory, and not be detectable via scanning the file system. An example of this type of malware would be a so-called worm that propagates from the memory of one machine to the memory of another by exploiting vulnerabilities in communication stacks.

For this reason, anti-virus software generally checks the contents of volatile memory (RAM) as well as the contents of the file system, in order to look for signatures of the various types of memory resident malware.

It should be noted that all computing devices are potentially subject to malware attacks, not simply desktop and laptop computers. Security loopholes have been exploited on other computing devices, including battery-powered mobile devices. In particular, it is apparent that for mobile computing devices such as smartphones, which remain either powered up or on standby for long periods of time and often use non-volatile flash memory technologies, memory based malware such as worms are clearly much more dangerous than they would be on mains-powered computers that employ volatile dynamic RAM and can rely on being regularly powered down to clear out memory-resident malware.

Current anti-virus software depends heavily on scanning file systems. However, there are problems with existing methods used for this purpose:
they may not detect a well concealed or polymorphic virus until the batch scan is performed
if the virus does not rely on being written to disk at all (e.g. a pure network virus), it in may never be detected
it adds an overhead to every file access (even non-executable files, in case they contain embedded executables)
efficient implementation at the operating system level generally requires the scanner to be co-located with the file system driver, which itself can open a security vulnerability, since if a virus attacks the scanner itself, it may gain unfettered access to the entire file-system
deep scans in particular can result in many scans of executables or other files without them ever being invoked; as well as slowing the operation of the device down, this is highly inefficient in terms of power consumption. On battery powered devices, any unnecessary use of power is detrimental to the functioning of the device, while even on mains powered devices it is to be deprecated because wasted energy contributes to global warming and environmental degradation.

As mentioned above, because it has been recognised that the scanning of file systems alone cannot detect memory malware, current anti-virus software usually also scans the device memory. However, existing methods of scanning memory also have drawbacks:
where memory scanning is triggered either when the anti-virus software first loads, or at fixed time intervals, any malware may already have been executed by the time a particular portion of memory is scanned
where memory scanning is triggered by alterations to the contents of memory, it is necessary to aggressively scan all such alterations, resulting in extreme degradation of performance
the whole of the device memory needs to be scanned, which is a considerable overhead when computing devices can have gigabytes of memory; this exacerbates the problems above
in systems that implement demand paging (where portions of virtual memory are kept on disk) the scanner also needs to be aware of which parts of memory actually reside in swap files, lest it degrades performance even further.
scanning memory is particularly burdensome for battery powered devices, because schemes that continually scan memory can lead to large increases in power consumption. Moreover, as pointed out above in connection with scanning disks, any unnecessary use of power is detrimental to the functioning of battery powered devices, while even on mains powered devices it is to be deprecated because wasted energy contributes to global warming and environmental degradation.

While keeping the same detailed methodology of scanning for the signature or fingerprints of malware, this invention discloses how a computer device can be arranged to implement a system for detecting and defeating malicious code infections in a way that is more efficient as well as more robust than existing anti-virus software scanning solutions.

According to a first aspect of the present invention there is provided a method of operating a computing device wherein the device is protected from executable malware by
a. separating executable from non-executable memory on the device; and
b. allowing the execution of any code from executable memory only; and
c. using a first software entity that is capable of scanning only the executable memory on the device for malware.

According to a second aspect of the present invention there is provided a computing device arranged to operate in accordance with the method of the first aspect.

According to a third aspect of the present invention there is provided an operating system for causing a computing device to operate in accordance with the method of the first aspect.

Embodiments of the present invention will now be described, by way of further example only, with reference to the accompanying drawings in which;

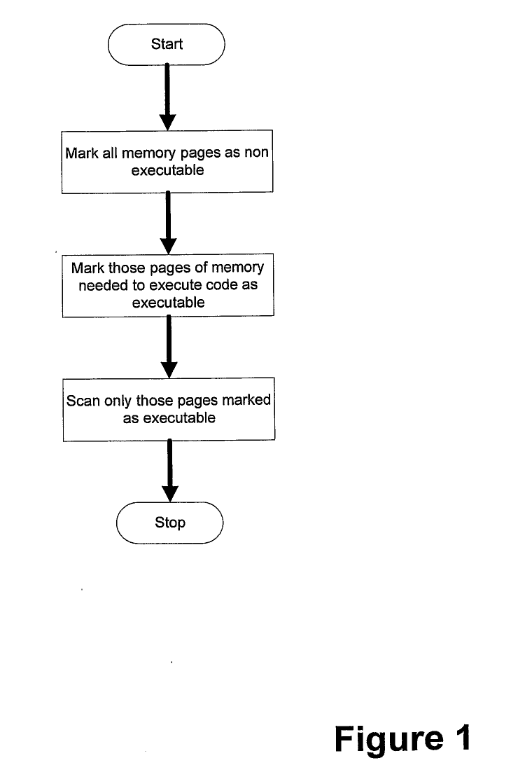

FIG. 1 shows a flow diagram of a method for virus scanning in accordance with the present invention:

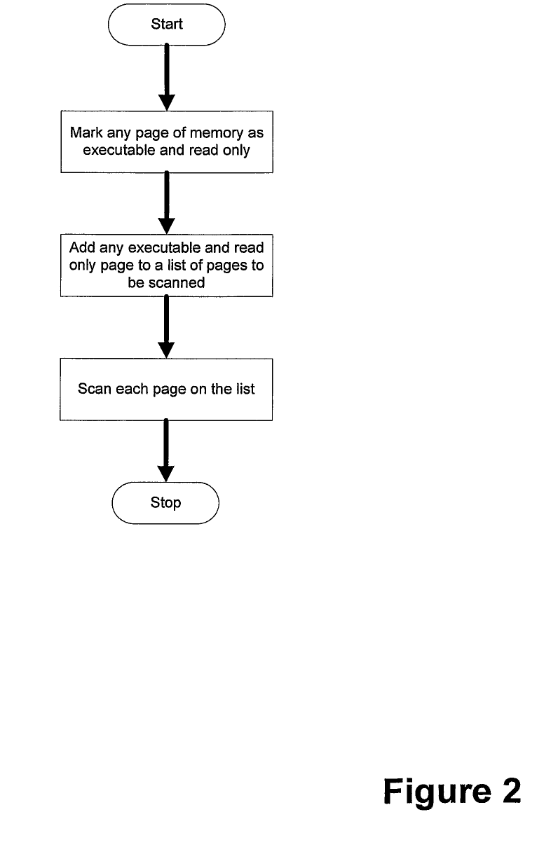

FIG. 2 shows a flow diagram of a method for virus scanning in which memory pages are marked as executable and read only; and

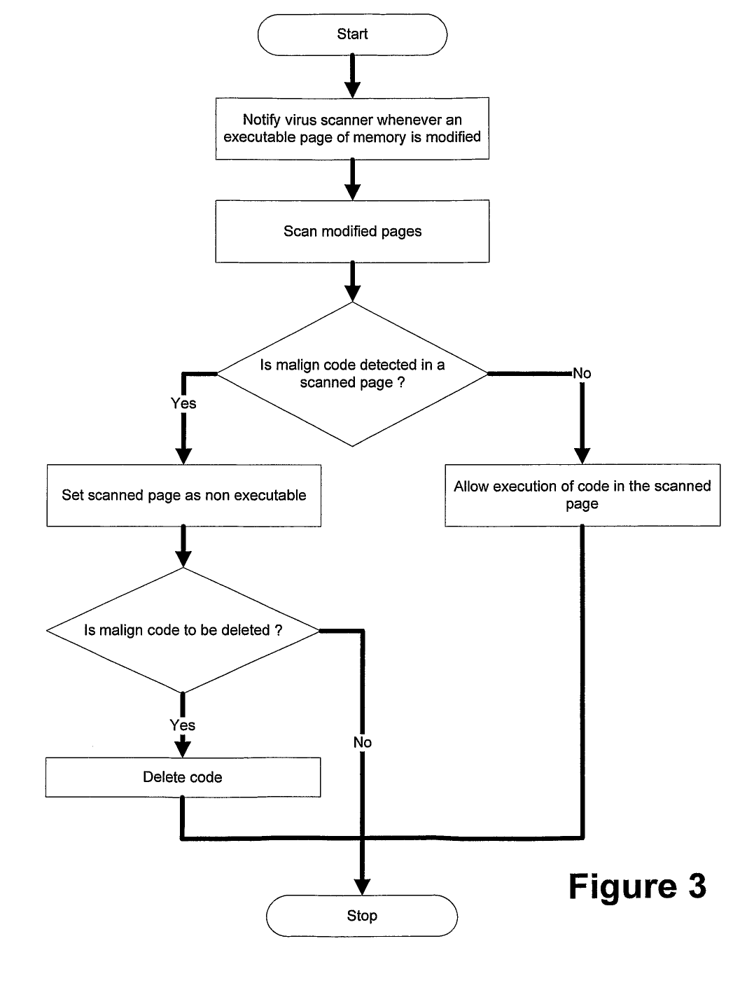

FIG. 3 shows a flow diagram of a method for virus scanning in accordance with the present invention in which modified executable pages of memory are scanned.

The perception behind this invention is that executable code stored on disk is in itself virtually harmless. Even when that code is loaded into memory, it still does no harm. It is only when the code is executed that it is given a chance to do harm. Therefore, provided a method can be found of identifying code that is about to be executed, it is quite possible to completely dispense with scanning the entire contents of memory, scanning filesystem reads and writes, and deep scans of the entire filesystem in the search for malware. By identifying code that is about to be executed, the scanning process can be made more efficient.

The basis of implementing the present invention is for the computing device to use a central processing unit (CPU) that can differentiate between those portions of memory that contain executable code and those that merely contain data, and for the anti-virus software in that computing device to be provided with a mechanism by which it is notified when there is a change in the contents of a portion of memory that contains code.

Suitable processors include those that conform with ARM Architecture version 6 (ARMv6) as designed by ARM pic of Cambridge, England, together with those that conform with Intel IA-32 designed by Intel Corporation of Santa Clara, Calif., USA. In common with many other processors that incorporate memory management functionality, these CPUs divide accessible memory up into pages. However, as disclosed at http://www.arm.com/pdfs/ARMv6_Architecture.pdf and at http://cache-www.intel.com/cd/00/00/14/93/149307_{—}149307.pdf, pages may be marked as non-executable, in which case they cannot be used for executing code. The ARM architecture achieves this by setting an XN bit for each page of memory, where XN stands for Execute Never, while Intel achieve the marking of memory pages by setting an Execute Disable bit.

It should be noted that while Intel disclose that the Execute Disable bit is provided to stop malware from executing code in data pages, this is clearly aimed at preventing attacks by malware exploits such as stack and buffer overflows, there is no hint whatsoever in the Intel disclosure of the use of such a mechanism to improve the efficiency of and lessen the power wastage inherent in virus scanning operations, as is disclosed in the present invention.

One implementation of this invention is shown in FIG. 1, and the operating system (or any comparable controlling software) for the computing device will support this type of non-executable memory pages. In this embodiment, by default all memory is marked as non-executable until it is needed for executing code, when it is explicitly unmarked: marked as executable. It can be seen that once such unmarking is implemented, an immediate effect is that the scan search space for a virus check is greatly reduced because only those pages of memory marked as executable need to be scanned for native code based viruses. The pages of memory which are still marked as non-executable pages can be ignored because the code that they contain cannot be run and cause malicious harm.

However, a further implementation of this invention is to provide a mechanism for notifying the anti-virus software either directly or via the operating system when the contents of one of the executable pages of memory changes; this enables rescanning of memory to take place only when necessary and the need for complete memory scans is thereby minimised.

There are a number of ways in which this notification mechanism may be implemented. Two (non exclusive) suggested methods are as follows:
1. Interactive: This method is shown in FIG. 2 and makes use of the fact that many processors, including the ARM and Intel architectures mentioned above, are additionally able to mark memory pages as being write protected, or read only. An Application Programming Interface (API) is provided to a client application on a computing device which must call for a memory region to be allocated so that it can run on the device. In this embodiment, when the memory region is allocated, simultaneously, for the memory pages concerned, the non-executable bit is toggled off and the write-protect bit is toggled on. All pages of the memory to be used are therefore either in Writeable or Executable states: pages can never be writable and executable simultaneously and the device will therefore never allow writes to an executable page. Hence, the client application, which may contain malicious code, can be written to the required pages because they have been toggled as ‘Writeable’. However, when the client application requests any page to be toggled from writeable to executable, the page is immediately marked read-only and added to a list of pages to be scanned. Only after the anti-virus software has successfully completed its scan does the client API call return. If the scan result is clean, the page is then marked as executable as well as read-only so the client code in the page concerned can run on the device but no new code can be written to the page because the page is marked as read-only. However, if the scan detects any suspect code, the state change will fail and the page will revert to being marked as writeable and non-executable. Optionally the entire contents of the memory page might then be wiped.

For most existing software on most computing devices, the program loader is the only entity that needs to be modified to use the above APIs. Any attempt to bypass the program loader would inevitably fail, as such attempts would be trying to execute code from a non-executable page.
2. Responsive: This requires no API changes at all, and does allow executable pages to be written to. However, the virus scanner is notified via the operating system kernel whenever an executable page has been modified, and it then sets about scanning the page. If malign code is discovered, the scanner indicates this to the kernel which sets the non-executable page flag (and optionally wipes the contents of the page). For better responsiveness, the scan can proceed asynchronously if there is no risk of the suspect code being executed; the operating system kernel kernel can suspend any thread if it attempts to execute the code in this page before the virus scan has been successfully completed.

The responsive mode may be implemented by setting up special exception handlers within the memory manager which can trigger an interrupt when any attempt is made to modify the contents of an executable page; the mechanism suggested will be familiar to those skilled in the art as it is analogous to that of a page fault. However, other methods of notification are possible and it is not intended that the present invention be limited by the mechanism suggested.

The implementations described above are provided for illustrative purposes only and it is not intended that the present invention be limited only to the particular implementations. The present invention can be implemented in many ways and on many different operating systems and on many different computing devices without departing from the scope of the invention disclosed herein.

It can be seen from the above description that several advantages accrue through the use of the present invention
File scanning becomes almost redundant.
All code that can be executed is scanned and can be certified as malware free; it does not need to be scanned again unless its memory page is written to.
This removes the inefficiency and security risk posed by file-system virus scanner hooks.
Only memory that is marked as executable needs to be scanned.
The virus scanner does not need to be aware of any changes in the binary file format, or in any compression algorithms used on it.
Self modifying viral code would automatically be subject to exactly the same re-scanning requirements.
The memory scanning API does not pose the same security risk or overhead as a file system plugin. It is invoked relatively less often (executable code is loaded far less often than the disk is accessed) and it can be implemented very efficiently across memory boundaries, by virtue of the fact RAM pages can be made visible to many processes. The consequences of API misuse are just those of denial of service (deny code from being loaded) rather than unfettered file-system access. Only executable code needs to be revealed to this scanner, not every file ever loaded.
As well as the gains in utility and reliability, the extra efficiency gains obtained through this invention save power; for battery operated devices this prolongs their use on one set of batteries or on a single charge, while the power savings for all computing devices translate directly to less wasted energy, less global warming and less pollution of the environment.

Although the present invention has been described with reference to particular embodiments, it will be appreciated that modifications may be effected whilst remaining within the scope of the present invention as defined by the appended claims.

1. A method of operating a computing device wherein the device is protected from executable malware by
a. separating executable from non-executable memory on the device; and
b. allowing the execution of any code from executable memory only; and
c. using a first software entity that is capable of scanning only the executable memory on the device for malware.

2. A method according to claim 1 wherein the memory on the computing device is comprised of pages which can be set as either executable or non executable.

3. A method according to claim 1 wherein the said first software entity scans the executable memory on the device for malware in response to a notification that the contents of executable memory on the device has been altered.

4. A method according to claim 3 wherein the notification is that a single page of executable memory has been altered and wherein the first software entity responds by scanning only the page that has been altered.

5. A method according to claim 4 wherein outstanding notifications or requests for pages to be scanned are held in a queue until they can be processed.

6. A method according to claim 3 wherein a software application seeking to execute code from altered executable memory is blocked from doing so until the altered memory has been scanned for malware.

7. A method according to claim 6 wherein detection of malware in altered executable pages causes a software application seeking to execute its contents to be aborted.

8. A method according to claim 6 wherein detection of malware in altered executable code causes the memory detected as containing the malware to be wiped.

9. A method according to claim 2 wherein the computing device is arranged such that writable memory cannot be executed and executable memory cannot be written to, and wherein a second software entity is enabled to mark pages in the memory as being either writable or executable.

10. A method according to claim 9 wherein a software application seeking to execute code from one or more writable memory pages makes a request to the said second software entity that the pages be made executable, and wherein the said second software entity does not fulfill the request until the first software entity has first marked the pages as read-only and then scanned the pages for malware.

11. A method according to claim 10 wherein the detection of malware in memory pages causes the said memory pages to be marked as writable rather than executable.

12. A method according to claim 10 wherein the detection of malware in memory pages causes a software application seeking to execute its contents to be aborted.

13. A method according to claim 10 wherein detection of malware in memory pages causes the contents of the pages to be wiped.

14. A method of operating a computing device comprising a combination of a method according to claim 3 with a method according to claim 9.

15. A computing device programmed to implement a method according to claim 1.

16. An operating system for causing a computing device to operate in accordance with a method as claimed in claim 1.
